(19) United States
(12) Patent Application Publication
(10) Pub. No.: US 2026/0288464 A1
(43) Pub. Date: Sep. 24, 2026

(54) TASK DELEGATION

(71) Applicant: Arm Limited, Cambridge (GB)

(72) Inventors: Mbou Eyole, Cambridge (GB); Richard Roy Grisenthwaite, Cambridge (GB); Robert Gwilym Dimond, Cambridge (GB)

(73) Assignee: Arm Limited, Cambridge (GB)

(21) Appl. No.: 19/490,140

(22) PCT Filed: Feb. 9, 2024
(86) PCT No.: PCT/GB2024/050353

§ 371 Date: Dec. 4, 2025

(30) Foreign Application Priority Data
Jun. 5, 2023 (GB) 2308371.0

(51) Int. Cl. G06F 9/30; G06F 9/38

(52) U.S. Cl. CPC G06F 9/3016; G06F 9/3867

(57) ABSTRACT

Apparatuses, methods of data processing, computer program, and computer-5 readable media are disclosed. A data processing pipeline performs data processing operations in dependence on a received sequence of instructions. Extension processing circuitry associated with the data processing pipeline and performs a delegated task in response to a delegation signal received from the data processing pipeline. Decoding the received sequence of instructions generates control signals to control the data processing pipeline to perform the data processing operations. The decoding is responsive to an extension start instruction specifying the delegated task to: generate the control signals to control the data processing pipeline to issue the delegation signal to the extension processing circuitry to delegate the delegated task to the extension processing circuitry. The extension processing circuitry performs the delegated task asynchronously to the data processing operations performed by the data processing pipeline.

### TASK DELEGATION

The present techniques relate to an apparatus, a method of operating an apparatus, a computer program, and a computer-readable medium.

An apparatus may comprise a data processing pipeline configured to perform data processing operations in dependence on a received sequence of instructions.

At least some examples herein provide an apparatus for data processing, comprising:
a data processing pipeline configured to perform data processing operations in dependence on a received sequence of instructions; and
extension processing circuitry associated with the data processing pipeline and configured to perform a delegated task in response to a delegation signal received from the data processing pipeline,
wherein the data processing pipeline comprises decoding circuitry configured to decode the received sequence of instructions and to generate control signals to control the data processing pipeline to perform the data processing operations,
wherein the decoding circuitry is responsive to an extension start instruction specifying the delegated task to:
   generate the control signals to control the data processing pipeline
wherein the data processing pipeline is configured to issue the delegation signal to the extension processing circuitry to delegate the delegated task to the extension processing circuitry, and
wherein the extension processing circuitry is configured to perform the delegated task asynchronously to the data processing operations performed by the data processing pipeline.

At least some examples herein provide a non-transitory computer-readable medium to store computer-readable code for fabrication of the apparatus.

At least some examples herein provide a method of data processing, comprising:
performing data processing operations in a data processing pipeline in dependence on a received sequence of instructions;
performing a delegated task in extension processing circuitry associated with the data processing pipeline in response to a delegation signal received from the data processing pipeline;
decoding in decoding circuitry the received sequence of instructions generate control signals to control the data processing pipeline to perform the data processing operations,
wherein the decoding is responsive to an extension start instruction specifying the delegated task to:
   generate the control signals to control the data processing pipeline to issue the delegation signal to the extension processing circuitry to delegate the delegated task to the extension processing circuitry; and
performing the delegated task in the extension processing circuitry asynchronously to the data processing operations performed by data processing pipeline.

At least some examples herein provide a computer program for controlling a host data processing apparatus to provide an instruction execution environment, the computer program comprising:
data processing pipeline logic for performing data processing operations in dependence on a received sequence of instructions; and
extension processing logic associated with the data processing pipeline logic and configured to perform a delegated task in response to a delegation signal received from the data processing pipeline logic,
wherein the data processing pipeline logic comprises decoding logic configured to decode the received sequence of instructions and to generate control signals to control the data processing pipeline logic to perform the data processing operations,
wherein the decoding circuitry is responsive to an extension start instruction specifying the delegated task to:
   generate the control signals to control the data processing pipeline logic
wherein the data processing pipeline logic is configured to issue the delegation signal to the extension processing logic to define delegate the delegated task to the extension processing logic, and
wherein the extension processing logic is configured to perform the delegated task asynchronously to the data processing operations performed by data processing pipeline logic.

The present techniques will be described further, by way of example only, with reference to embodiments thereof as illustrated in the accompanying drawings, to be read in conjunction with the following description, in which:

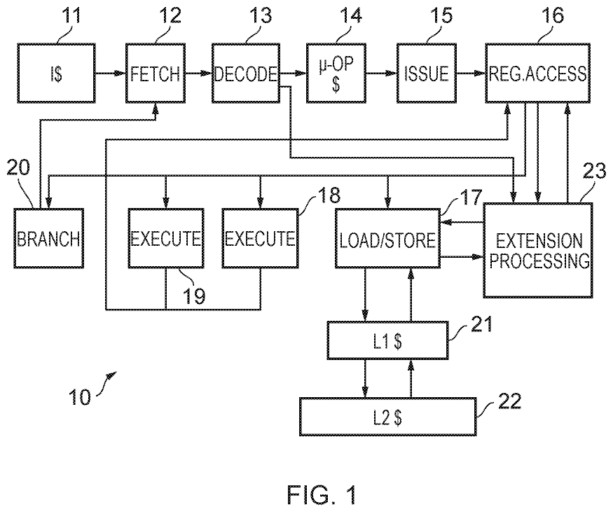

FIG. 1 schematically illustrates a data processing apparatus which may embody various examples of the present techniques;

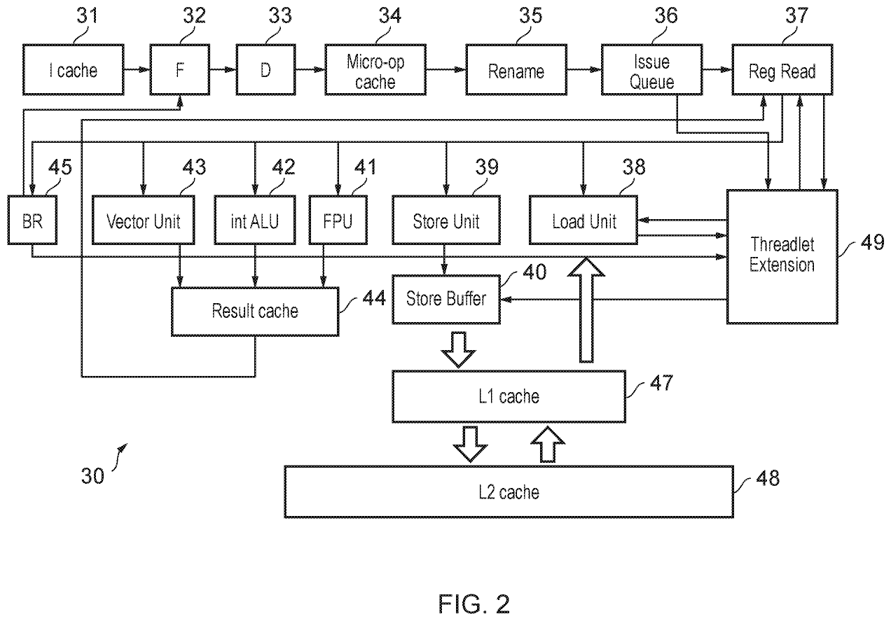

FIG. 2 schematically illustrates a data processing apparatus which may embody various examples of the present techniques;

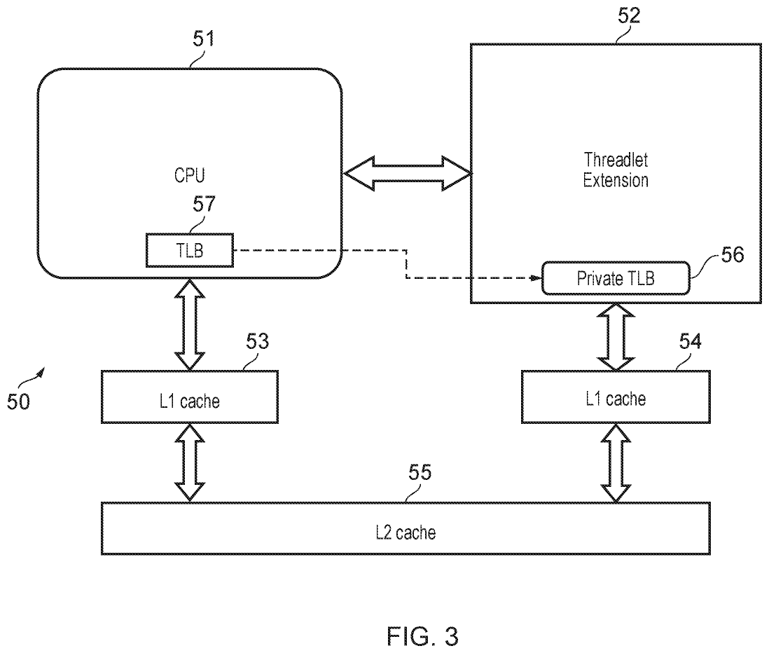

FIG. 3 schematically illustrates a data processing apparatus which may embody various examples of the present techniques;

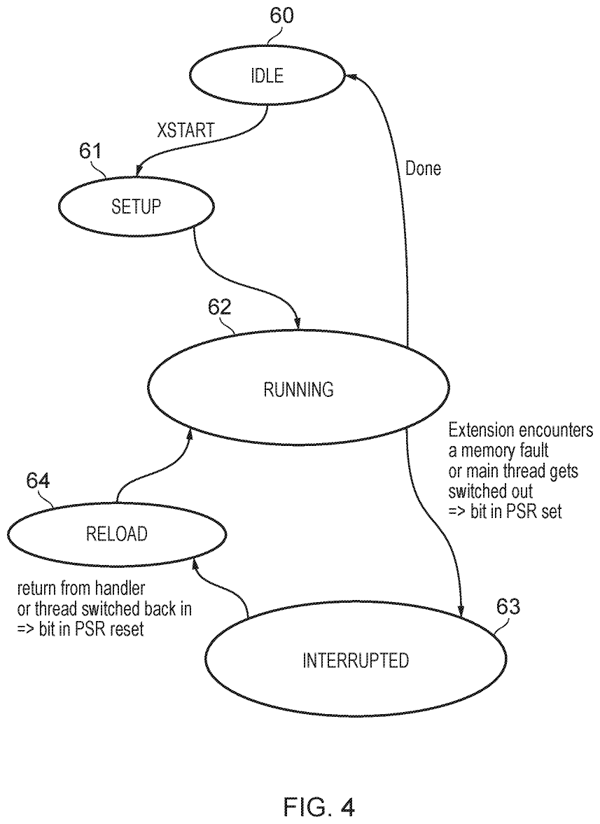

FIG. 4 is a state diagram illustrating an example set of states between which extension processing circuitry of the present techniques may transition;

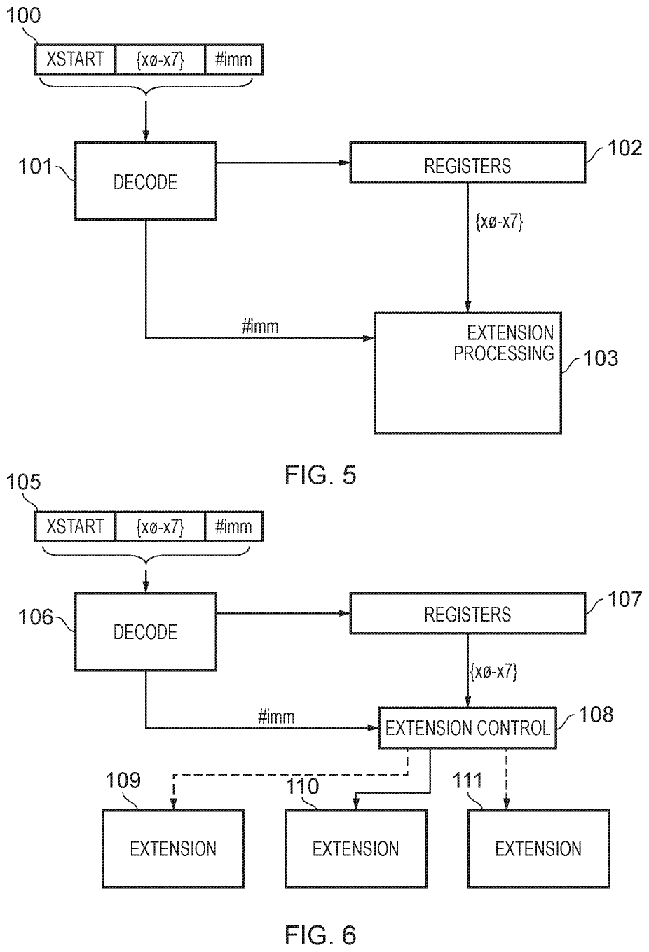

FIG. 5 schematically illustrates an extension start instruction delegating a task to extension processing circuitry in accordance with some examples;

FIG. 6 schematically illustrates an extension start instruction delegating a task to one of several instances of extension processing circuitry in accordance with some examples;

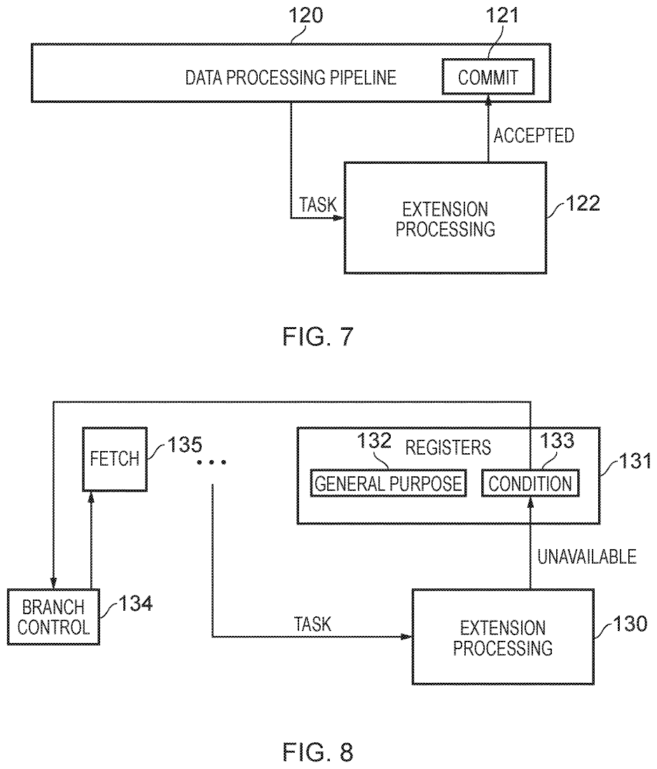

FIG. 7 schematically illustrates extension processing circuitry accepting a delegated task in accordance with some examples;

FIG. 8 schematically illustrates extension processing circuitry indicating its unavailability to accept a delegated task in accordance with some examples;

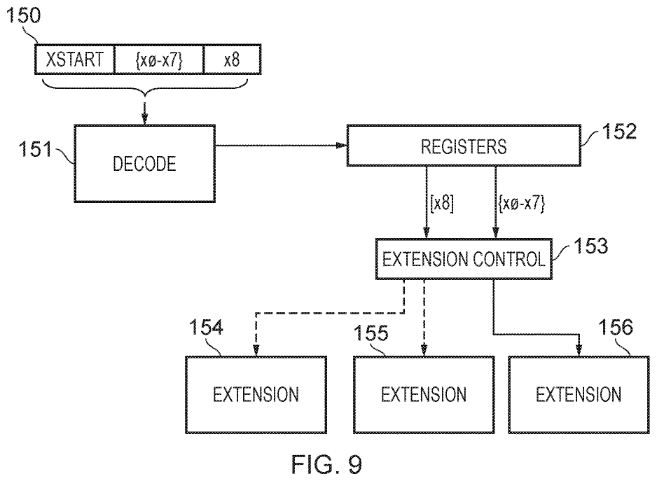

FIG. 9 schematically illustrates an extension start instruction delegating a task to one of several instances of extension processing circuitry in accordance with some examples;

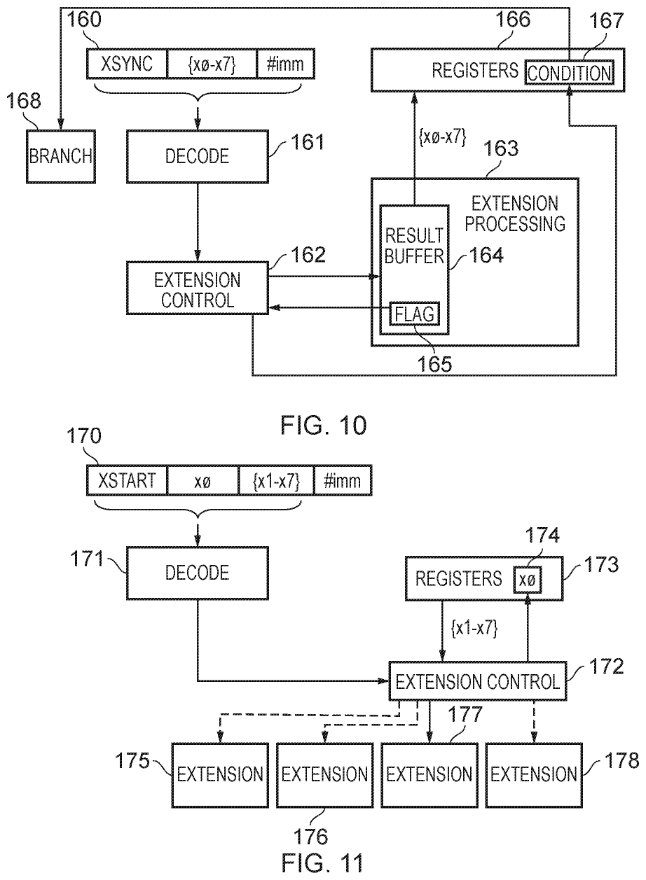

FIG. 10 schematically illustrates an extension synchronisation instruction causing the results of a delegated task to be transferred from extension processing circuitry into a set of registers belonging to the data processing pipeline in accordance with some examples;

FIG. 11 schematically illustrates an extension start instruction delegating a task to one of several instances of extension processing circuitry in accordance with some examples;

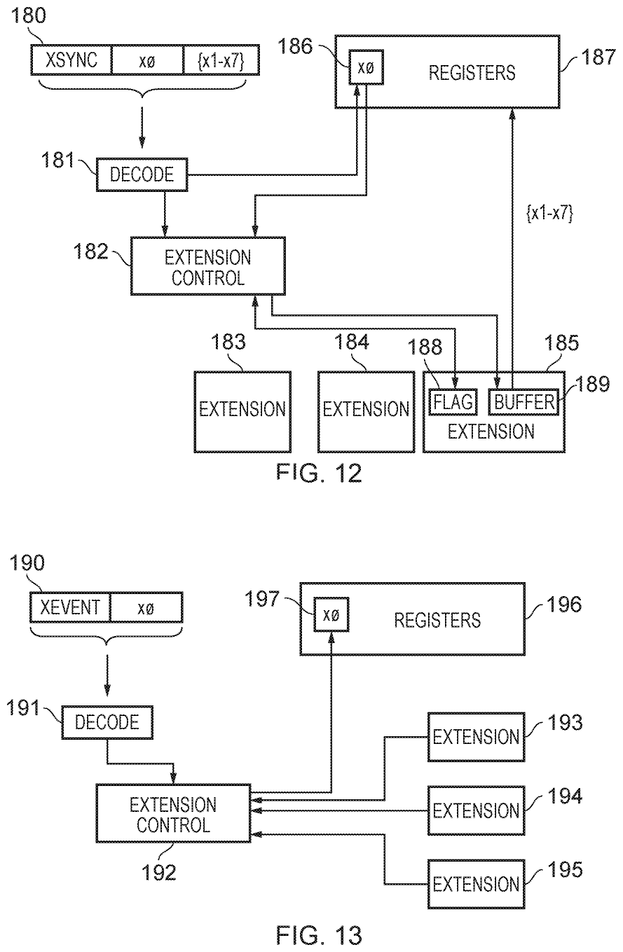

FIG. 12 schematically illustrates an extension synchronisation instruction causing the results of a delegated task to be transferred from one of several instances of extension processing circuitry into a set of registers belonging to the data processing pipeline in accordance with some examples;

FIG. 13 schematically illustrates an extension event instruction causing an identifier of one of several instances of extension processing circuitry which has completed a delegated task to be written to a register belonging to the data processing pipeline in accordance with some examples;

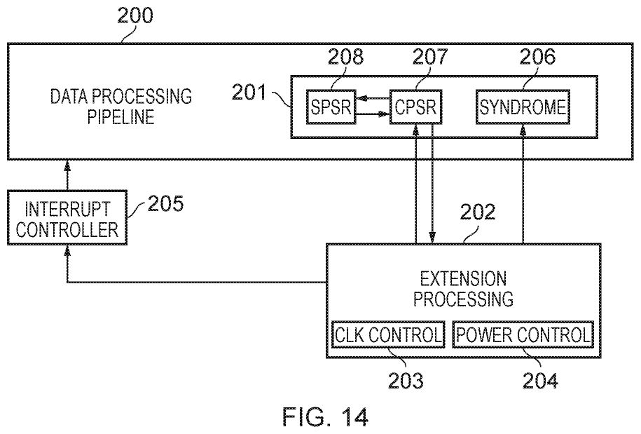

FIG. 14 schematically illustrates extension processing circuitry which has encountered a memory fault or other processing disruption signalling this event to the data processing pipeline in accordance with some examples;

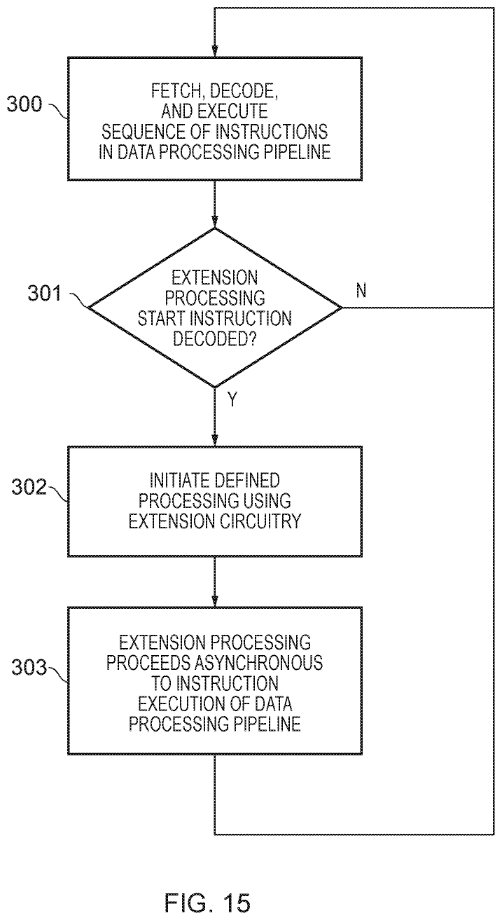

FIG. 15 is a flow diagram showing a sequence of steps that are taken in the method of some examples; and

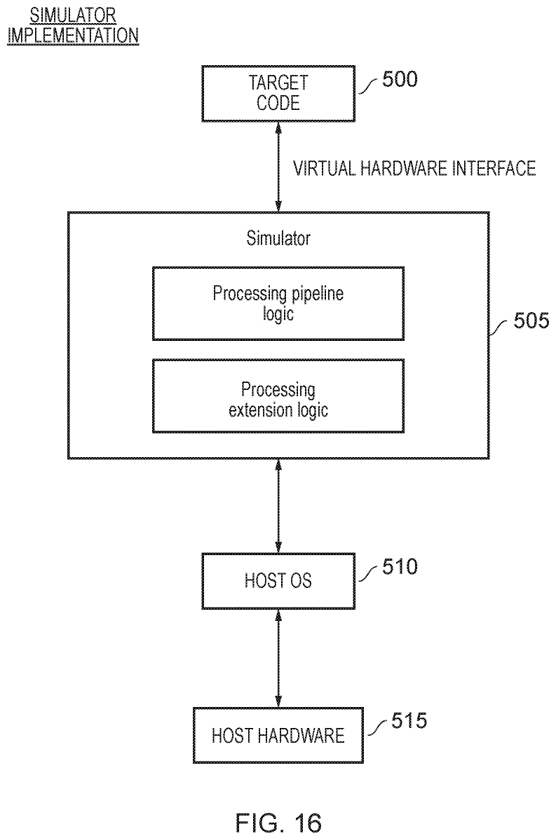

FIG. 16 schematically illustrates a simulator implementation that may be used.

In one example herein there is an apparatus for data processing, comprising:
a data processing pipeline configured to perform data processing operations in dependence on a received sequence of instructions; and
extension processing circuitry associated with the data processing pipeline and configured to perform a delegated task in response to a delegation signal received from the data processing pipeline,
wherein the data processing pipeline comprises decoding circuitry configured to decode the received sequence of instructions and to generate control signals to control the data processing pipeline to perform the data processing operations,
wherein the decoding circuitry is responsive to an extension start instruction specifying the delegated task to:
   generate the control signals to control the data processing pipeline
wherein the data processing pipeline is configured to issue the delegation signal to the extension processing circuitry to delegate the delegated task to the extension processing circuitry, and
wherein the extension processing circuitry is configured to perform the delegated task asynchronously to the data processing operations performed by the data processing pipeline.

An apparatus comprising a data processing pipeline can be required to perform a limitless variety of data processing operations as defined by the sequence of instructions provided to it. In order efficiently to perform those data processing operations, the data processing pipeline may be configured with a variety of functional units, each with a given specialised type of data processing ability, such as arithmetic logic units (ALUs), floating point (FP) units, load/store units, and so on. Yet even with such specialised functional units being provided as part of the data processing pipeline, the inventors of the present techniques have established that in some types of data processing, that is in certain programs (i.e. sequences of instructions), there can be particular functions which are frequently executed and which require an amount of processing, such that the provision of custom hardware dedicated to supporting these functions is worthwhile, since it could significantly impact the overall performance of the apparatus. In identifying such functions, two key properties were deemed to be relevant: a function's ubiquity (i.e. it can also be found in the many other use-cases) and a function's impact (i.e. the proportion of time spent executing such a function is a significant percentage of the overall runtime, such that improvements in its execution made a significant difference to the overall use-case). Such impactful, ubiquitous functions have been found to include tasks or functions such as memcpy, memset, compression, encryption, and string processing, although the present techniques are not limited to these particular examples. The present techniques provide extension processing circuitry that is associated with the data processing pipeline and is configured to perform such a function (a delegated task) in response to a delegation signal received from the data processing pipeline. Such extension processing circuitry may also be referred to as a threadlet extension (TE) herein. The sequence of operations it carries out to perform the defined function may also be referred to as a threadlet herein. The extension processing circuitry, although closely associated (tightly coupled) with the data processing pipeline, is configured to perform the delegated task asynchronously to the data processing operations performed by data processing pipeline. The data processing pipeline may also be referred to as the CPU herein. Threadlets are functions or collections of operations that can be executed asynchronously relative to other CPU activity once launched. The asynchronous operation of the extension processing circuitry with respect to the data processing pipeline is possible because, unlike some prior art techniques, the extension processing circuitry receives a directive or command from the thread currently executing on the CPU and performs the required operations independently, that is without requiring a stream of instructions from the CPU that directly control or influence its internal operation. The CPU is therefore free to continue executing other code and potentially reduce overall runtime by overlapping the execution of the instruction stream after the directive or command is sent to the extension processing circuitry with the operation of the extension processing circuitry. The directive or command sent to the extension processing circuitry to initiate the delegated task is generated in response to an extension start instruction defined for this purpose in the instruction set of the data processing pipeline. Accordingly, the decoding circuitry is responsive to the extension start instruction to issue the delegation signal to the extension processing circuitry to delegate the delegated task to the extension processing circuitry. Because of the tight integration of the extension processing circuitry with the data processing pipeline, the extension processing circuitry can be launched rapidly and its state can be checked in a short amount of time (e.g. of the order of a few ns) relative to some prior art techniques, which would require a great many CPU cycles for launching commands or performing synchronisation operations.

In some examples the data processing pipeline comprises a set of registers for holding data values on which the data processing operations are performed.

The delegation signal issued to the extension processing circuitry to delegate the delegated task may provide various information to the extension processing circuitry. In some examples, the data processing pipeline is configured to transfer at least one data value from the at least one register of the set of registers in association with the delegation signal to the extension processing circuitry. The close association of the extension processing circuitry (TE) with the data processing pipeline (CPU) means that the TE can get data directly from CPU registers at the start of its execution. Equally, upon completion it can return values directly to the CPU registers. Thus there is no need to rely on memory transfers for communicating with the launching thread on the CPU.

The at least one register of the set of registers from which the at least one data value is transferred may be implicit for the delegated task or the extension processing circuitry, or in some examples the extension start instruction specifies the at least one register of the set of registers, and the decoding circuitry is responsive to the extension start instruction to: generate the control signals to control the data processing pipeline to pass the at least one data value from the at least one register of the set of registers to the extension processing circuitry.

The extension start instruction may take a variety of forms, in particular it may define one or more operands associated with the instruction. In some examples the extension start instruction further specifies an operational identifier, wherein the operational identifier identifies at least one of: an extension processing circuitry identifier, when the apparatus comprises more than one instance of extension processing circuitry; and/or a delegated task identifier. Thus the operational identifier can be used to specify a particular instance of extension processing circuitry or a particular delegated task to be carried out. In some examples a given instance of extension processing circuitry is configured to carry out just one function, whereas in other examples a given instance of extension processing circuitry may be configured to perform one of several functions selectable by the use of the operational identifier.

In some examples the extension start instruction specifies a register of the set of registers from which to retrieve the operational identifier. In some other examples the extension start instruction specifies the operational identifier as an immediate value.

The data processing pipeline delegates the delegated task to the extension processing circuitry and can perform its own data processing whilst the delegated task is being carried out by the extension processing circuitry, yet this arrangement still requires the results of the delegated task to be available (despite the asynchronous execution of the delegated task) within a limited timeframe, such that those results can be integrated into the further data processing operations carried out by the data processing pipeline, without stalling the data processing pipeline whilst the delegated task completes. To address this, in some examples the data processing pipeline comprises a commit stage, at which an irrevocable modification of a state of the apparatus occurs when an executed instruction of the received sequence of instructions is committed, and the data processing pipeline is configured to suppress committing the extension start instruction until the extension processing circuitry has accepted the delegated task.

Nevertheless, if the extension processing circuitry cannot accepted the delegated task, this in itself could then stall the data processing pipeline and accordingly in some examples, the data processing pipeline is responsive to an unavailability signal from the extension processing circuitry regarding the delegated task to set at least one unavailable condition flag in a condition register of the set of registers. This setting of at least one unavailable condition flag may be used as a trigger for alternative action, for example by using a branch instruction that is sensitive to the relevant flags.

Thus in some examples the data processing pipeline is responsive to the at least one unavailable condition flag being set to divert (temporarily) from the received sequence of instructions to retrieve a fallback set of instructions and to perform a set of fallback data processing operations in dependence on the fallback set of instructions.

In a complementary manner to the initiation of the delegated task in response to an extension start instruction defined for this purpose in the instruction set of the data processing pipeline, an extension synchronisation instruction may also be defined in the instruction set to enable the results of a delegated task to be made use of. Thus in some examples, the decoding circuitry is responsive to an extension synchronisation instruction to:
generate the control signals to determine whether the extension processing circuitry has completed the delegated task; and
generate the control signals to control the extension processing circuitry to pass at least one result data value to at least one result register of the set of registers, when the extension processing circuitry has completed the delegated task.

The extension synchronisation instruction may take a variety of forms, in particular it may define one or more operands associated with the instruction. In some examples the extension synchronisation instruction specifies the at least one result register of the set of registers. Similarly to the extension start instruction, in some forms of the extension synchronisation instruction the data processing pipeline is configured to not commit the extension synchronisation instruction until the extension processing circuitry has completed the delegated task. When the extension synchronisation instruction is executed before the extension processing circuitry has completed the delegated task, this can be handled in a number of ways, but in some examples the data processing pipeline is responsive to a determination that the extension processing circuitry has not completed the delegated task to set at least one incomplete condition flag in a condition register of the set of registers.

In situations when the extension synchronisation instruction stalls in this manner, when the at least one incomplete condition flag is set this can be used as a trigger to allow some subsequent code to continue execution, e.g. by executing some alternative computation whilst it is waiting for the delegated task complete, for example by using a branch instruction that is sensitive to the relevant incomplete condition flag(s). Thus in some examples the data processing pipeline is responsive to the at least one incomplete condition flag being set to divert (temporarily) from the received sequence of instructions to retrieve an alternative set of instructions and to perform a further set of data processing operations in dependence on the alternative set of instructions.

In examples in which an extension start instruction initiates a delegated task which could be performed by more than one instance of extension processing circuitry, the extension start instruction may specify a register into which an identifier for the instance of the extension processing circuitry which was allocated the delegated task can be written. This identifier can then be used later on for checking completion of the delegated task. Thus in some examples the apparatus further comprises multiple instances of extension processing circuitry associated with the data processing pipeline and each instance is capable of performing the delegated task in response to the delegation signal received from the data processing pipeline, wherein the extension start instruction specifies an allocated extension register of the set of registers, and wherein the decoding circuitry is responsive to the extension start instruction to generate the control signals:
to cause the delegated task to be allocated to a selected instance of the extension processing circuitry; and
to control the data processing pipeline to write an identifier of the selected instance of the extension processing circuitry to the allocated extension register.

Thus in such examples the extension synchronisation instruction may specify the allocated extension register of the set of registers, and the decoding circuitry may be responsive to the extension synchronisation instruction to generate the control signals:
to generate the control signals to determine whether the selected instance of the extension processing circuitry indicated by the allocated extension register has completed the delegated task; and
to generate the control signals to control the selected instance of the extension processing circuitry to pass at the least one result data value to the at least one result register of the set of registers, when the selected instance of the extension processing circuitry has completed the delegated task.

Other associated instructions may be defined in the instruction set. Thus in some examples the apparatus comprises multiple instances of extension processing circuitry associated with the data processing pipeline and each instance is capable of performing the delegated task in response to the delegation signal received from the data processing pipeline,
wherein the decoding circuitry is responsive to an extension event instruction specifying an event-indicating register of the set of registers to:
   generate the control signals to control the data processing pipeline to identify an instance of extension processing circuitry that has completed the delegated task; and
   generate the control signals to cause an identifier of the instance of extension processing circuitry that has completed the delegated task to be written to the event-indicating register. This instruction is useful to mitigate the cost of software polling of the state of multiple instances of extension processing circuitry to determine which one has completed. The instruction returns the identifier of an instance of extension processing circuitry that has completed, so that the threadlet model can be more easily incorporated into event-driven software architectures.

Although the extension processing circuitry is closely associated with the data processing pipeline, the degree of integration of the extension processing circuitry with the data processing pipeline may vary. In some examples, the apparatus further comprises: a load/store queue; and a private cache for the data processing pipeline,
wherein the extension processing circuitry is configured to perform memory accesses via the load/store queue and the private cache. That is, the extension processing circuitry relies on the data processing pipeline's existing infrastructure for accessing memory.

In other examples, the extension processing circuitry, although still closely associated with the data processing pipeline, accesses memory with more independence and in some examples the apparatus further comprises:
an extension processing circuitry private cache; and
an extension processing circuitry address translation buffer.

In some examples, the extension processing circuitry is configured to flush the extension processing circuitry private cache on completion of the delegated task.

In some examples, the apparatus further comprises an address translation buffer configured to cache address translations used by the data processing pipeline,
wherein the data processing pipeline is configured to copy content of the address translation buffer to the extension processing circuitry address translation buffer when the delegated task is delegated to the extension processing circuitry. This “pre-warms” the extension processing circuitry address translation buffer to be able to more efficiently complete its delegated task.

It is recognised here that the extension processing circuitry may be disrupted whilst performing the delegated task, e.g. by the extension processing circuitry itself encountering a memory fault or by the main thread running on the data processing pipeline (i.e. the thread that triggered the threadlet) getting switched out. The present techniques propose a close integration of the extension processing circuitry into the data processing pipeline's exception handling capabilities. Hence in some examples the extension processing circuitry is responsive to a delegated task disruption:
to set a disruption bit in a current program status register of the set of registers to indicate the delegated task disruption; and
when the delegated task disruption is caused by a memory fault, to write an indication of the source of the fault to a syndrome system register of the set of registers and to assert an interrupt signal for the data processing pipeline. It should be noted that it is recognised here that the extension processing circuitry's ability to directly access the set of registers of the data processing pipeline may depend on the closeness of integration of the extension processing circuitry with the data processing pipeline. That is that deeply embedded examples of the extension processing circuitry may be able to access the set of registers essentially without intermediary, whilst less embedded examples (e.g. which have their own path to memory) may in practice access the set of registers via an intermediary interface.

Further, in some examples, when the delegated task disruption is caused by a context switch of the data processing pipeline, the data processing pipeline is configured to perform further data processing operations defined by a new context sequence of instructions, and
when the delegated task disruption is caused by the memory fault, the data processing pipeline is configured to perform further data processing operations defined by an exception handling sequence of instructions,
wherein in setting up the further data processing operations to be performed, the apparatus is configured to copy the current program status register to a saved program status register,
wherein, when the data processing pipeline reverts to the data processing operations defined by the received sequence of instructions, the data processing pipeline is configured to clear the disruption bit in the saved program status register and to copy the saved program status register to the current program status register,
and wherein the extension processing circuitry is responsive to the clear disruption bit in the current program status register to resume the disrupted delegated task.

Although the extension processing circuitry may be frequently used, there may also be periods of time when the extension processing circuitry is either idle (i.e. awaiting a newly delegated task) or interrupted (i.e. awaiting the resolution of a memory fault or the return from a context switch), and in order to provide improved power characteristics, in some examples the extension processing circuitry is configured to be at least one of: clock-gated; and/or power-gated, when the extension processing circuitry is not actively performing the delegated task.

In order to provide an interface via which the data processing pipeline can access the results of the delegated task and to determine the status of the extension processing circuitry, in some examples the extension processing circuitry comprises a data buffer, wherein the data buffer is configured to hold:
data processing results of the delegated task; and/or
an extension processing circuitry status indicator.

In one example herein there is a non-transitory computer-readable medium to store computer-readable code for fabrication of the apparatus of any of the above-described examples.

In one example herein there a method of data processing, comprising:
performing data processing operations in a data processing pipeline in dependence on a received sequence of instructions;
performing a delegated task in extension processing circuitry associated with the data processing pipeline in response to a delegation signal received from the data processing pipeline;
decoding in decoding circuitry the received sequence of instructions generate control signals to control the data processing pipeline to perform the data processing operations,
wherein the decoding is responsive to an extension start instruction specifying the delegated task to:
   generate the control signals to control the data processing pipeline to issue the delegation signal to the extension processing circuitry to delegate the delegated task to the extension processing circuitry; and
performing the delegated task in the extension processing circuitry asynchronously to the data processing operations performed by data processing pipeline.

In one example herein there is a computer program for controlling a host data processing apparatus to provide an instruction execution environment, the computer program comprising:
data processing pipeline logic for performing data processing operations in dependence on a received sequence of instructions; and
extension processing logic associated with the data processing pipeline logic and configured to perform a delegated task in response to a delegation signal received from the data processing pipeline logic,
wherein the data processing pipeline logic comprises decoding logic configured to decode the received sequence of instructions and to generate control signals to control the data processing pipeline logic to perform the data processing operations,
wherein the decoding circuitry is responsive to an extension start instruction specifying the delegated task to:
   generate the control signals to control the data processing pipeline logic wherein the data processing pipeline logic is configured to issue the delegation signal to the extension processing logic to define delegate the delegated task to the extension processing logic, and
wherein the extension processing logic is configured to perform the delegated task asynchronously to the data processing operations performed by data processing pipeline logic.

Some particular embodiments are now described with reference to the figures.

FIG. 1 schematically illustrates a data processing apparatus 10 according to some examples. The data processing apparatus 10 is schematically shown to have a pipelined configuration, which for the purposes of brevity and clarity is shown in a conceptual representation here. The illustrated pipeline stages comprise an instruction cache 11, a fetch stage 12, a decode stage 13, a micro-op cache 14, an issue stage 15, and a register access stage 16. A sequence of instructions is retrieved from memory (not shown) and cached in the instruction cache 11. The fetch stage 12 controls which instructions are retrieved as the sequence of instructions and these instructions are then decoded in the decode stage 13. This decoding essentially identifies the type of each instruction, as well as any further operands specified by the instruction, and generates control signals to control the remainder of the apparatus to perform the data processing operation(s) defined by the instruction. Decoding the instructions may comprise splitting an instruction into one or more micro-ops, and these micro-ops can be cached in the micro-op cache 14. The final stage of the pipeline before execution is the issue stage 15, where instructions (or micro-ops) are queued pending the availability of the register values they specify as operands and the corresponding functional unit of the data processing pipeline which will carry out the defined operation. Generally the data processing operation(s) defined by the instructions are carried out by the functional units that form part of the data processing pipeline, namely the load/store unit 17, the execute unit 18, and the execute unit 19. These latter execute units may for example be arithmetic logic units (ALUs), floating point units (FPUs), and so on. The functional units that form part of the data processing pipeline perform their data processing operations on data values which are provided from a set of registers (conceptually represented by the register access stage 16 in the figure) and result values of those data processing operations are returned to the set of registers. The load/store unit 17 is provided for the purpose of storing values from the set of registers to the memory system, of which only a level 1 cache 21 and a level 2 cache 22 are shown in the figure. The L1 cache 21 is private to the data processing apparatus 10 and the L2 cache 22 may be shared with another data processing apparatus, when part of a wider data processing system. The data processing apparatus 10 is also shown to comprise a branch unit 20, which monitors execution flow of the sequence of instructions and seeks to predict, based on previous execution history, whether a given branch will be taken or not. The predictions from the branch unit 20 inform the sequence of instructions caused to be fetched by the fetch stage 12.

The data processing apparatus 10 further comprises extension processing circuitry 23, which is provided to support efficient performance of one or more defined functions, which have been established to be impactful and ubiquitous for the data processing operations which this data processing apparatus 10 carries out. Example functions of this type have been found to include tasks or functions such as memcpy, memset, compression, encryption, and string processing, although the present techniques are not limited to these particular examples. The extension processing circuitry is closely associated with the data processing pipeline and is configured to perform the defined function (also referred to herein as a delegated task) in response to a delegation signal received from the data processing pipeline. The extension processing circuitry 23 is an example of a threadlet extension (TE) according to the present techniques. The sequence of operations it carries out to perform the defined function is referred to as a threadlet herein. The extension processing circuitry 23, although closely associated with the data processing pipeline, is configured to perform the delegated task asynchronously to the data processing operations performed by data processing pipeline. The data processing pipeline may also be referred to as the CPU herein. Threadlets are functions or collections of operations that can be executed asynchronously relative to other CPU activity once launched. The directive or command sent to the extension processing circuitry 23 to initiate the delegated task is generated in response to an extension start instruction defined for this purpose in the instruction set of the data processing pipeline. Thus, an extension start instruction progresses along the data processing pipeline in the manner that any other CPU instruction would, but when the decoding circuitry 13 identifies the extension start instruction it can signal directly to the extension processing circuitry 23. The close integration of the extension processing circuitry 23 with data processing pipeline is illustrated by the fact that the extension processing circuitry 23 has direct access to the load/store unit 17, and thus it shares the data processing pipeline's path to memory. The extension processing circuitry 23 also has access to the set of registers 16, such that for example, the extension start instruction can specify one or more registers as operands, and the values from these registers are then passed directly to the extension processing circuitry 23 in association with the command sent to initiate the delegated task. Upon completion of the task, results of the delegated task can be returned to the register values via an extension synchronisation instruction.

FIG. 2 schematically illustrates a data processing apparatus 30 according to some examples. It will be noted that the arrangement of components of the data processing apparatus 30 is similar to that of the components of the data processing apparatus 10 shown in FIG. 1. One difference is that whilst the data processing apparatus 10 of FIG. 1 is intended to represent an in-order processor, the data processing apparatus 30 is an out-of-order processor. As one consequence of this the data processing pipeline of the data processing apparatus 30 comprises a rename stage 35, allowing the data processing apparatus 30 to vary the order in which it executes instructions of the sequence of instructions, such that they can be executed in an order dictated by when their operands become available, and the availability of functional units, rather than the order in which they appear in the sequence. The illustrated pipeline stages comprise an instruction cache 31, a fetch stage 32, a decode stage 33, a micro-op cache 34, the rename stage 35, an issue stage 36, and a register access stage 37. A sequence of instructions is retrieved from memory (not shown) and cached in the instruction cache 31. Instructions pass through the data processing pipeline in the manner described above with reference to the data processing apparatus 10 of FIG. 1, with the further register renaming that is performed by the rename stage 35. The functional units of the data processing pipeline in this example are the load unit 38, the store unit 39, the FPU 41, the integer ALU 42, and the vector unit 43. The throughput of the FPU 41, the integer ALU 42, and the vector unit 43 is sufficient that a result cache 44 is provided an intermediary before results of their data processing are returned to the registers 37. A branch prediction unit 45 is also provided and its predictions inform the operation of the fetch stage 32.

The data processing apparatus 30 further comprises extension processing circuitry (“threadlet extension”) 49, which is provided to support efficient performance of one or more defined functions, which have been established to be impactful and ubiquitous for the data processing operations which this data processing apparatus 30 carries out. The extension processing circuitry 49 is closely associated with the data processing pipeline and is configured to perform the defined function in response to a delegation signal received from the data processing pipeline. In the example of FIG. 2, this delegation signal is shown emanating from the issue queue stage 36. Notably, this is after the rename stage 35, such that the extension processing circuitry 49 can operate with respect to the physical registers of the set of registers 37 according to the same mapping of architectural registers used for the rest of the apparatus. As in the example of FIG. 1, the data processing pipeline (instruction cache 31 through to the register read stage 37, the load/store units 38 and 39, and the functional units 41-45) may also be referred to as the CPU. The threadlet extension 49 operates asynchronously relative to other CPU activity once launched. The directive or command sent to the extension processing circuitry 49 to initiate the delegated task is generated in response to an extension start instruction defined for this purpose in the instruction set of the data processing pipeline. The close integration of the extension processing circuitry 49 with data processing pipeline also apparent in this example by the fact that the extension processing circuitry 49 has direct access to the load unit 38 and the store buffer 40, and thus it shares the data processing pipeline's path to memory. The extension processing circuitry 49 also has access to the set of registers 37, such that for example, the extension start instruction can specify one or more registers as operands, and the values from these registers are then passed directly to the extension processing circuitry 49 in association with the command sent to initiate the delegated task. Note that the output of the branch prediction unit 45 is also provided to the extension processing circuitry 49. Upon completion of the task, results of the delegated task can be returned to the register values via an extension synchronisation instruction.

FIG. 3 schematically illustrates a data processing apparatus 50 according to some examples. This example provides a comparison to the examples of FIG. 1 and FIG. 2, in which examples the extension processing circuitry was closely embedded with the data processing pipeline, to the extent that those instances of extension processing circuitry may be considered to be within the CPU. In the example apparatus 50 of FIG. 3, the CPU 51 and the extension processing circuitry (threadlet extension) 52 are not as closely integrated. For example this is illustrated by the fact that each has its own path to memory, with an L1 cache 53 private to the CPU 51 and an L1 cache 54 private to the threadlet extension 52. They share the L2 cache 55. Nevertheless, the threadlet extension 52 remains tightly coupled to the CPU 51, and can be launched quickly when an extension start instruction is encountered in the CPU pipeline specifying the function this threadlet extension 52 performs. The threadlet extension 52 can get data directly from CPU registers at the start of its execution. Upon completion, it can return values via an extension synchronisation instruction. FIG. 3 also shows the threadlet extension 52 as having its own private TLB 56, in which it can cache currently used address translations. As a preparatory step before or associated with the delegation signal, content from the TLB 57 in the CPU 51 can be copied into the private TLB 56 in order to pre-warm this cache before the threadlet begins operation.

FIG. 4 is a state diagram illustrating an example set of states between which a extension processing circuitry (TE) transitions in some examples. Initially the TE is in an IDLE state 60. When an extension start (XSTART) instruction is encountered by the data processing pipeline, a delegation signal can cause the TE switches to the SETUP state 61. This may also require a signal indicating that the XSTART instruction has been committed to be asserted. In the SETUP state 61, certain actions necessary for preparing the TE can be performed, for example, in examples in which the TE has a separate path to memory (as in the case of FIG. 3), one setup task is the transfer of relevant entries currently in the CPU's TLB to a private TLB within the TE. This enables the TE to perform translations independently at a faster rate than if it were to rely entirely on the existing translation mechanism within the CPU. If the TE has been in a clock-gated or power-gated condition when in the IDLE state 60, the SETUP state 61 may also comprise the task of exiting the TE from that clock-gated or power-gated condition. Once the SETUP state 61 is complete the TE can switch to the RUNNING state 62. If the TE encounters a memory fault during its processing, it asserts a signal which will raise an interrupt within the CPU, causing it to stop executing the main thread and switch to a handler. The TE switches to the INTERRUPTED state 63. An indication of the source of the fault is placed in a special syndrome system register, the address associated with the fault is stored in the fault address system register, and a bit in the Program Status Register (PSR) will be set enabling the handler to quickly determine the source of the fault. Setting a bit in the PSR makes communicating the resumption of the threadlet straightforward, because the handler can reset the relevant bit in the SPSR and when the CPSR is restored from the SPSR during exception return, the TE can detect the resetting of this bit and resume executing. The TE will also switch to the INTERRUPTED state 63 if the main thread gets switched out, e.g. during a context-switch initiated by the operating system. In the INTERRUPTED state 63, the TE may be clock-gated or power-gated, unless some other thread launches a new command directed at it or the associated thread returns resumes execution or the handler returns. The TE returns from the INTERRUPTED state 63 to the RUNNING state 62 via the RELOAD state 64 in which any context or state relevant to its execution, which was previously saved to memory, can be restored. This might be the case if another thread made use of a TE which was previously interrupted. Finally, when the extension reaches the end of the offloaded granule of computation (the delegated task) it moves to the IDLE state 60. The TE will advertise completion of the task, so that an extension synchronisation instruction (XSYNC) can pick up that “done” signal and, if required, provide a return value to a specified register. If the TE has any lingering data in its private caches it might also need to flush these entries upon completion.

An example of using threadlets is now set out. The programmer or compiler identifies functions whose execution in custom hardware (extension processing circuitry) satisfies the cost-benefit thresholds in their use-case. An instruction (such as XSTART) is used to launches a command within the designated CPU extension. An example use written in pseudo-code (for such an identified function “funcX”) is as follows:

```
funcA ( ) {
  ...
  XSTART {x0 − x3}, #imm_op //funcX(a, b, c, d);
  I1
  I2
  I3
  I4
  ...
  XSYNC x0, #imm_op
  ...
}
```

Thus, within the function funcA, the XSTART instruction initializes the CPU extension and transfers to the extension processing circuitry the parameters (a, b, c, d) for funcX, which are in registers x0, x1, x2, x3 respectively. The XSTART instruction in this example also specifies the immediate value #imm_op, which defines the specific function to be carried out. For example, whilst there might only be one instance of extension processing circuitry, it may be capable of performing more than one function, or at least more than one variant of a function, and the immediate value #imm_op can select the desired variant and/or function. In other examples there may be more than one instance of extension processing circuitry and the immediate value #imm_op can select between them. Depending on the setup, the extension could also automatically get a copy of relevant entries in the TLB. The extension processing circuitry then carries out the task required (funcX) and during its execution, the CPU is free to carry on executing other instructions I1, I2, I3, I4, etc. At some point in the future, the CPU executes an extension synchronisation instruction (XSYNC) which automatically checks whether the extension has completed or not. If it has not, for some variants of the extension synchronisation instruction, the CPU will wait for the delegated task to complete. Other variants of the extension synchronisation instruction (e.g. the XSYNCS variant) allow the CPU can carry on executing other code (if there are alternative routines available or stop executing and wait for completion of the extension (typically if there is nothing else to execute in the interim). There are a range of variations of XSTART and XSYNC proposed herein, and these are discussed in more detail with reference to the figures which follow.

FIG. 5 schematically illustrates an extension start instruction delegating a task to extension processing circuitry in accordance with some examples. Here the XSTART instruction takes the form: XSTART {x0-x7}, #imm. Thus an XSTART instruction 100 of this form, when decoded by the CPU's decoder 101, causes the content of registers x0-x7 to be retrieved from the registers 102 and passed to the extension processing circuitry 103. In this case the extension processing circuitry 103 can perform multiple types of operation (task) and the immediate value #imm (or signals based on the immediate value #imm) selects between them.

FIG. 6 schematically illustrates an extension start instruction delegating a task to one of several instances of extension processing circuitry in accordance with some examples. Here, the XSTART instruction also takes the form: XSTART {x0-x7}, #imm. However in this example, there are multiple instances of extension processing circuitry and the immediate value #imm is used to select between them. Thus an XSTART instruction 105 of this form, when decoded by the CPU's decoder 106, causes the content of registers x0-x7 to be retrieved from the registers 102. Extension control circuitry 108, on the basis of the immediate value #imm (or signals based on the immediate value #imm) directs the register values to the selected extension processing circuitry 110. In this case, the other instances of extension processing circuitry 109 and 111 are not activated by this instruction.

FIG. 7 schematically illustrates extension processing circuitry accepting a delegated task in accordance with some examples. The data processing pipeline 120 is shown to conclude with a commit stage 121. An instruction which passes through this data processing pipeline 120 will finally be committed, when it is definitively known that this instruction should be executed, or will be cancelled when it is established that this instruction should not be executed. For example, when the data processing pipeline follows a prediction for a particular branch made by its branch prediction unit, only when that branch is resolved as taken or not taken can further instruction which were provisionally executed on the assumption that the branch prediction was correct be committed. Here, an XSTART instruction has caused a task to be delegated to the extension processing circuitry 122, but until the extension processing circuitry 122 signal the data processing pipeline 120 that it is accepting the task, the XSTART instruction will not commit, so it will effectively stall if the extension processing circuitry is already executing a task or is otherwise unavailable.

FIG. 8 schematically illustrates extension processing circuitry indicating its unavailability to accept a delegated task in accordance with some examples. Thus, when the data processing pipeline seeks to delegate a task to the extension processing circuitry 130, and the extension processing circuitry 130 is already executing a task or is otherwise unavailable, the extension processing circuitry 130 indicates its unavailability by causing a flag to be set in a condition register of the set of registers 131. Other general purpose registers 132, for example which might have provided parameters for the task if it had been accepted are not accessed. In some examples the condition register flag may be one or more NZCV flag bits. Setting these bits signals the unavailability of the extension processing circuitry 130 to the data processing pipeline, which could as a result access other code to continue execution e.g. execute a fallback routine by using a branch instruction that is sensitive to the relevant flag bits in the condition register 133. The branch control 134, with this input, can then cause the fetch unit 135 to divert to access that other code for the fallback routine. Thus this variety of extension start instruction (XSTARTS) is non-blocking and can commit, even though the task was not delegated.

FIG. 9 schematically illustrates an extension start instruction delegating a task to one of several instances of extension processing circuitry in accordance with some examples. Here, the XSTART instruction takes the form: XSTART {x0-x7}, x8. In this example there are multiple instances of extension processing circuitry 154, 155, 156, and the content of register x8 is used to select between them. Thus an XSTART instruction 150 of this form, when decoded by the CPU's decoder 151, causes the content of registers x0-x7 to be retrieved from the registers 152. In addition, content from register x8 is passed to the extension control circuitry 153, which directs the register values x0-x7 to the selected extension processing circuitry 156. In this case, the other instances of extension processing circuitry 154 and 155 are not activated by this instruction.

FIG. 10 schematically illustrates an extension synchronisation instruction (XSYNC) causing the results of a delegated task to be transferred from extension processing circuitry into a set of registers belonging to the data processing pipeline in accordance with some examples. Here the XSYNC instruction takes the form: XSYNC {x0-x7}, #imm. When an XSYNC instruction 100 of this form is decoded by the CPU's decoder 161, it first causes extension control circuitry 162 to determine if the flag 165 forming part of the result buffer 164 of the extension processing circuitry 163 is set to indicate that the extension processing circuitry 163 has completed a delegated task and has results ready. When the flag 165 indicates that the task is complete, the extension control circuitry 162 causes the results from the result buffer 164 to be passed to registers x0-x7 of the set of registers 166. Use of the immediate value #imm is not explicitly shown in this example, but it can be used to select between multiple instances of extension processing circuitry or to control another aspect of the result collection process. In the event that the flag 165 indicates that the task is not complete, the extension control circuitry 162 causes a flag to be set in a condition register 167 of the set of registers 166 in the manner described above with reference to FIG. 8. Similarly therefore, the condition register flag may be one or more NZCV flag bits. Setting this flag signals that the extension processing circuitry 163 has not yet completed the task to the data processing pipeline, which could as a result access other code to continue execution whilst it is waiting, e.g. by using a branch instruction that is sensitive to the relevant flag bits in the condition register 167. The branch control 168, with this input, can then cause the diversion that other code interim routine. Thus this variety of extension synchronisation instruction (XSYNCS) is non-blocking and can commit, even though the task was complete when the instruction was executed.

FIG. 11 schematically illustrates an extension start instruction delegating a task to one of several instances of extension processing circuitry in accordance with some examples. Here, the XSTART instruction takes the form: XSTART x0, {x1-x7}, #imm. In this example there are multiple instances of extension processing circuitry 175, 176, 177, 178, but the XSTART instruction does not dictate which of them is to be delegated the task. Instead a register x0 is nominated for an indicator of the selected instance of extension processing circuitry to be stored. Thus an XSTART instruction 170 of this form, when decoded by the CPU's decoder 171, causes the content of registers x1-x7 to be retrieved from the registers 173. In addition, the extension control circuitry 172 determines which of the instances of extension processing circuitry should receive the task. This may be determined by availability, by relative capability of the instances, or another factor. The extension control circuitry 172 directs the register values x1-x7 to the selected extension processing circuitry 177 (in this case) and causes a corresponding indicator to be written to register x0 174. Use of the immediate value #imm is not explicitly shown in this example, but it can be used influence the selection between multiple instances of extension processing circuitry made by the extension control circuitry 172 or to define some aspect of the delegated task.

FIG. 12 schematically illustrates an extension synchronisation instruction causing the results of a delegated task to be transferred from one of several instances of extension processing circuitry into a set of registers belonging to the data processing pipeline in accordance with some examples. Here, the XSYNC instruction takes the form: XSYNC x0, {x1-x7}. In this example there are multiple instances of extension processing circuitry 183, 184, 185, but the XSYNC instruction does not dictate which of them has been delegated the task. Instead the register x0 specified as where an indicator of the selected instance of extension processing circuitry 185 is stored. This may have been written there by an XSTART instruction of the type discussed with reference to FIG. 12. Thus an XSYNC instruction 180 of this form, when decoded by the CPU's decoder 181, causes the content of register x0 186 to be retrieved from the registers 187. This tells the extension control circuitry 172 which of the instances of extension processing circuitry should be examined to determine if it has completed a delegated task. To do so, the extension control circuitry 172 examines the flag 188 which the extension processing circuitry 185 makes externally accessible. When the flag 188 indicates that the delegated task is complete, the extension control circuitry 182 causes the results to be transferred from the buffer 189 to the registers x1-x7 of the set of registers 187. Use of an immediate value #imm in the XSYNC instruction 180 is not shown in this example, but it could be added as a control of some aspect of retrieving the delegated task results. Note also that both blocking (XSYNC) and non-blocking (XSYNCS) of the instruction in FIG. 12 are proposed, with the non-blocking version XSYNCS operating as described for FIG. 10.

FIG. 13 schematically illustrates an extension event instruction causing an identifier of one of several instances of extension processing circuitry which has completed a delegated task to be written to a register belonging to the data processing pipeline in accordance with some examples. This instruction is useful to mitigate the cost of software polling of the state of multiple instances of extension processing circuitry to determine which one has completed. Here, the XEVENT instruction takes the form: XEVENT x0. Thus an XEVENT instruction 190 of this form, when decoded by the CPU's decoder 191, causes the extension control circuitry 172 to determine whether one of the instances of extension processing circuitry 193, 194, 195 has completed a delegated task. To do so, the extension examines the above-described flag that each makes available. When one of the instances of extension processing circuitry 193, 194, 195 has completed a delegated task the extension control circuitry 172 returns (via x0 in this case), the identifier of the extension processing circuitry that has completed. This enables the threadlet model to be more easily incorporated into event-driven software architectures.

FIG. 14 schematically illustrates extension processing circuitry 202 which has encountered a memory fault or other processing disruption signalling this event to the data processing pipeline 200 in accordance with some examples. The illustrated extension processing circuitry 202, when in its RUNNING state (see FIG. 4) may encounter a disruption to its processing, either because processing of the extension processing circuitry 202 itself encounters a memory fault during its processing or because the main thread (executing on the data processing pipeline 200) gets switched out, e.g. during a context-switch initiated by the operating system. When such a disruption occurs, the extension processing circuitry 202 asserts a signal to the interrupt controller, which raises an interrupt within the CPU (data processing pipeline 200), causing it to stop executing the main thread and switch to a handler. The TE extension processing circuitry 202 writes an indication of the source of the fault to a syndrome register 206 and sets a bit in the current program status register (CPSR) 207 enabling the handler to quickly determine the source of the fault. The handler triggered by the interrupt received from the interrupt controller 205 takes appropriate action to deal with the memory fault. Whilst the handler is running, or when the other context which was switched in is operating, the content of the current program status register (CPSR) 207 (from the point at which the extension processing circuitry 202 was interrupted) is stored in the saved program status register 208. Setting a bit in the CPSR, which is then copied to the SPSR, makes communicating the resumption of the threadlet straightforward, because the handler can reset the relevant bit in the SPSR and when the CPSR is restored from the SPSR during exception return, the extension processing circuitry 202 can detect the resetting of this bit and resume executing. When in its INTERRUPTED state the extension processing circuitry 202 may be clock-gated or power-gated, control of which is provided by the clock control 203 and the power control 204.

FIG. 15 is a flow diagram showing a sequence of steps that are taken in the method of some examples. The flow can be considered to begin at step 300 where the data processing pipeline (the CPU) in in an ongoing process of fetching, decoding, and executing a sequence of instructions. Step 301 determines whether an extension processing start instruction is decoded as part of the sequence of instructions. Whilst it is not the flow simply continually loops back via step 300. When such an extension processing start instruction is decoded, the flow proceeds to step 302, at which defined processing (defined by that extension processing start instruction) is initiated on extension processing circuitry (here it is assumed that such extension processing circuitry is available to start immediately). Step 303 shows the extension processing circuitry proceeding with its processing asynchronously to the instruction execution of the data processing pipeline. The flow is shown to return to step 300 for the ongoing process of fetching, decoding, and executing a sequence of instructions for the data processing pipeline to continue. In the meantime the asynchronous processing of the extension processing circuitry continues, until the extension processing circuitry completes the delegated task.

FIG. 16 schematically illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 515, optionally running a host operating system 510, supporting the simulator program 505. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 515), some simulated embodiments may make use of the host hardware, where suitable.

The simulator program 505 may be stored on a computer-readable storage medium (which may be a non-transitory medium), and provides a program interface (instruction execution environment) to the target code 500 (which may include applications, operating systems and a hypervisor) which is the same as the interface of the hardware architecture being modelled by the simulator program 505. Thus, the program instructions of the target code 500 may be executed from within the instruction execution environment using the simulator program 505, so that a host computer 515 which does not actually have the hardware features of the apparatuses discussed above can emulate these features.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary, apparatuses, methods of data processing, computer program, and computer-readable media are disclosed. A data processing pipeline performs data processing operations in dependence on a received sequence of instructions. Extension processing circuitry associated with the data processing pipeline and performs a delegated task in response to a delegation signal received from the data processing pipeline. Decoding the received sequence of instructions generates control signals to control the data processing pipeline to perform the data processing operations. The decoding is responsive to an extension start instruction specifying the delegated task to: generate the control signals to control the data processing pipeline to issue the delegation signal to the extension processing circuitry to delegate the delegated task to the extension processing circuitry. The extension processing circuitry performs the delegated task asynchronously to the data processing operations performed by the data processing pipeline.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

1. Apparatus for data processing, comprising:
a data processing pipeline configured to perform data processing operations in dependence on a received sequence of instructions; and
extension processing circuitry associated with the data processing pipeline and configured to perform a delegated task in response to a delegation signal received from the data processing pipeline,
wherein the data processing pipeline comprises decoding circuitry configured to decode the received sequence of instructions and to generate control signals to control the data processing pipeline to perform the data processing operations,
wherein the decoding circuitry is responsive to an extension start instruction specifying the delegated task to:
generate the control signals to control the data processing pipeline to issue the delegation signal to the extension processing circuitry to delegate the delegated task to the extension processing circuitry, and
wherein the extension processing circuitry is configured to perform the delegated task asynchronously to the data processing operations performed by the data processing pipeline.

2. (canceled)

3. The apparatus as claimed in claim, wherein the data processing pipeline comprises a set of registers for holding data values on which the data processing operations are performed; and
wherein the data processing pipeline is configured to transfer at least one data value from the at least one register of the set of registers in association with the delegation signal to the extension processing circuitry.

4. The apparatus as claimed in claim 3, wherein the extension start instruction specifies the at least one register of the set of registers, and the decoding circuitry is responsive to the extension start instruction to:
generate the control signals to control the data processing pipeline to pass the at least one data value from the at least one register of the set of registers to the extension processing circuitry.

5. The apparatus as claimed in claim 1, wherein the extension start instruction further specifies an operational identifier, wherein the operational identifier identifies at least one of:
an extension processing circuitry identifier; and/or
a delegated task identifier.

6. The apparatus as claimed in claim 5, wherein the data processing pipeline comprises a set of registers for holding data values on which the data processing operations are performed; and
the extension start instruction specifies a register of the set of registers from which to retrieve the operational identifier.

7. The apparatus as claimed in claim 5, wherein the extension start instruction specifies the operational identifier as an immediate value.

8. The apparatus as claimed in claim 1, wherein the data processing pipeline comprises a commit stage, at which an irrevocable modification of a state of the apparatus occurs when an executed instruction of the received sequence of instructions is committed, and
wherein the data processing pipeline is configured to suppress committing the extension start instruction until the extension processing circuitry has accepted the delegated task.

9. The apparatus as claimed in claim 1, wherein the data processing pipeline comprises a set of registers for holding data values on which the data processing operations are performed; and
the data processing pipeline is responsive to an unavailability signal from the extension processing circuitry regarding the delegated task to set at least one unavailable condition flag in a condition register of the set of registers.

10. The apparatus as claimed in claim 9, wherein the data processing pipeline is responsive to the at least one unavailable condition flag being set to divert from the received sequence of instructions to retrieve a fallback set of instructions and to perform a set of fallback data processing operations in dependence on the fallback set of instructions.

11. The apparatus as claimed in claim 21, wherein the data processing pipeline comprises a set of registers for holding data values on which the data processing operations are performed and;
the decoding circuitry is responsive to an extension synchronisation instruction to:
generate the control signals to determine whether the extension processing circuitry has completed the delegated task; and
generate the control signals to control the extension processing circuitry to pass at least one result data value to at least one result register of the set of registers, when the extension processing circuitry has completed the delegated task.

12. The apparatus as claimed in claim 11, wherein the extension synchronisation instruction specifies the at least one result register of the set of registers.

13. The apparatus as claimed in claim 11, wherein the data processing pipeline is responsive to a determination that the extension processing circuitry has not completed the delegated task to set at least one incomplete condition flag in a condition register of the set of registers.

14. The apparatus as claimed in claim 13, wherein the data processing pipeline is responsive to the at least one incomplete condition flag being set to divert from the received sequence of instructions to retrieve an alternative set of instructions and to perform a further set of data processing operations in dependence on the alternative set of instructions.

15. The apparatus as claimed in claim 21, wherein the data processing pipeline comprises a set of registers for holding data values on which the data processing operations are performed;
further comprising multiple instances of extension processing circuitry associated with the data processing pipeline and each instance is capable of performing the delegated task in response to the delegation signal received from the data processing pipeline,
wherein the extension start instruction specifies an allocated extension register of the set of registers, and wherein the decoding circuitry is responsive to the extension start instruction to generate the control signals:
to cause the delegated task to be allocated to a selected instance of the extension processing circuitry; and
to control the data processing pipeline to write an identifier of the selected instance of the extension processing circuitry to the allocated extension register.

16. (canceled)

17. The apparatus as claimed in claim 21, wherein the data processing pipeline comprises a set of registers for holding data values on which the data processing operations are performed;
the apparatus comprises multiple instances of extension processing circuitry associated with the data processing pipeline and each instance is capable of performing the delegated task in response to the delegation signal received from the data processing pipeline, and
the decoding circuitry is responsive to an extension event instruction specifying an event-indicating register of the set of registers to:
generate the control signals to control the data processing pipeline to identify an instance of extension processing circuitry that has completed the delegated task; and
generate the control signals to cause an identifier of the instance of extension processing circuitry that has completed the delegated task to be written to the event-indicating register.

18. The apparatus as claimed in claim 1, further comprising:
a load/store queue; and
a private cache for the data processing pipeline,
wherein the extension processing circuitry is configured to perform memory accesses via the load/store queue and the private cache.

19. The apparatus as claimed in claim 1,
further comprising:
an extension processing circuitry private cache; and
an extension processing circuitry address translation buffer.

20. (canceled)

21. (canceled)

22. (canceled)

23. (canceled)

24. (canceled)

25. (canceled)

26. A non-transitory computer-readable medium to store computer-readable code for fabrication of the apparatus of claim 1.

27. A method of data processing, comprising:
performing data processing operations in a data processing pipeline in dependence on a received sequence of instructions;
performing a delegated task in extension processing circuitry associated with the data processing pipeline in response to a delegation signal received from the data processing pipeline;
decoding in decoding circuitry the received sequence of instructions generate control signals to control the data processing pipeline to perform the data processing operations,
wherein the decoding is responsive to an extension start instruction specifying the delegated task to:
generate the control signals to control the data processing pipeline to issue the delegation signal to the extension processing circuitry to delegate the delegated task to the extension processing circuitry; and
performing the delegated task in the extension processing circuitry asynchronously to the data processing operations performed by data processing pipeline.

28. A computer program for controlling a host data processing apparatus to provide an instruction execution environment, the computer program comprising:
data processing pipeline logic for performing data processing operations in dependence on a received sequence of instructions; and
extension processing logic associated with the data processing pipeline logic and configured to perform a delegated task in response to a delegation signal received from the data processing pipeline logic,
wherein the data processing pipeline logic comprises decoding logic configured to decode the received sequence of instructions and to generate control signals to control the data processing pipeline logic to perform the data processing operations,
wherein the decoding circuitry is responsive to an extension start instruction specifying the delegated task to:
generate the control signals to control the data processing pipeline logic to issue the delegation signal to the extension processing logic to delegate the delegated task to the extension processing logic, and
wherein the extension processing logic is configured to perform the delegated task asynchronously to the data processing operations performed by data processing pipeline logic.
